(19) United States
(12) Patent Application Publication
(10) Pub. No.: US 2023/0311347 A1
(43) Pub. Date: Oct. 5, 2023

(54) COMPACT ROBOT CELL

(71) Applicant: Demmeler Automatisierung und Roboter GmbH, Heimertingen (DE)

(72) Inventor: Johannes DEMMELER, Heimertingen (DE)

(21) Appl. No.: 18/016,294

(22) PCT Filed: Jul. 15, 2021
(86) PCT No.: PCT/EP2021/069702

§ 371 Date: Jan. 13, 2023

(30) Foreign Application Priority Data
Jul. 16, 2020 (DE) 10 2020 208 939.6

(51) Int. Cl. B25J 21/00; B25J 11/00; F16P 1/06

(52) U.S. Cl. CPC B25J 21/00; B25J 11/0055; F16P 1/06

(57) ABSTRACT

The present invention relates to a compact cell Z having a protective enclosure 3 for welding operations by means of welding robots 15, having a protective enclosure 3 consisting of a roof 1, side walls 2, a front side 4A and a rear side 4B, said protective enclosure 3 being movable from a first position into a second and back again by a guide rail 23 supported on a pneumatically actuable guide device 24, and as a result being able to enclose a front working area A1 in the first position and a rear working area A2 in the second position, respectively. The front side 4A and rear side 4B of the protective enclosure 3 furthermore comprise at least in each case one roller shutter device (22A; 22B) which can open and close roller shutters (5A; 5B) that close the entire side or modularly combinable roller shutters (18; 20) on respective roller shutter mounts (V1; V2; V3) integrated in the roof 1.

The present invention relates to a compact cell with a protective enclosure for welding operations by means of welding robots, in which a working area to be enclosed can be adapted in a modular manner by moving a protective enclosure.

### BACKGROUND OF INVENTION

Generic robot cells for welding processes known from the state of the art usually comprise one or more working areas, embodied by a working surface or other receptacles fixing a workpiece, a movable welding robot as well as an outer enclosure enclosing the welding robot and the working surface, which protects the welder during the welding operations of the welding robot and directs the welding fumes produced into an extraction device provided. The protective enclosure is usually equipped with a door, a window or at least curtains so that the welder can quickly reach the respective working area during a workpiece exchange or for manual settings on the welding robot.

DE212012000203U1 shows a cell enclosure for a welding cell unit with expandable wall structure elements, in which individual wall geometries can be changed and adapted to the requirements of the robot movement in order to temporarily increase the movement range of the welding robot system.

It is an object of the present invention to configure a generic welding robot cell in such a way that it has the most compact shape possible with the best possible accessibility to the respective working areas. In addition, it is an object to optimise the structure of the welding robot cell so that the available working areas can be used as optimally as possible without neglecting the protection of the welder.

### DETAILED DESCRIPTION OF THE INVENTION

To solve the above mentioned object, the features of the independent claims are proposed. The dependent claims concern preferred embodiments of the present invention.

The compact cell with a protective enclosure for welding operations and/or cutting operations by means of welding robots may comprise a protective enclosure consisting of at least a cell roof and a cell side wall, which may be connected to a cell base frame by a guide device and can thus be moved in both directions from a first to a second position in order to enclose an at least first or second working area integrated in the compact cell. The guide device may preferably be controlled pneumatically, but in further preferred embodiments it may also be controlled with motor, electrical and/or pneumatic support. Furthermore, the protective enclosure may include a roller shutter device at least at the front and rear side, which can move roller shutters up and down in a modular manner to enclose the respective working area located in the protective enclosure, thus providing preferential access to the respective working area. The movement of the protective enclosure from one position to the next may also expose at least one working area for a welder, whereas another working area may be completely closed by the protective enclosure and thus used as a working surface for the welding robot installed in the compact cell. This configuration provides a cost-effective and at the same time flexible configuration of a robot welding cell. In particular, the movement of the protective enclosure and the resulting modularly switchable working areas enable an optimised, safe parallel work of the welder during the welding operations of the robot, while at the same time a maximum working area ratio can be made available. In addition, this arrangement offers a high degree of compactness and transportability due to its advantageous design, so that it can be easily integrated into already existing systems and loaded from at least 3 of 4 sides and from the top.

In a preferred further embodiment, the protective enclosure comprises four side walls, each including at least one roller shutter device. The above mentioned cell side wall may therefore be formed by a roller shutter device in this further embodiment, so that easy accessibility from all sides is possible. In this further embodiment, the protective enclosure is configured as a portal on (preferably four) columns, wherein a roller shutter device and/or a welding curtain may be provided between each of these columns. Particularly preferably, a welding curtain may also be provided on at least one and preferably on all sides of the protective enclosure.

In a preferred embodiment, the first working area may preferably be a front working area facing the front of the protective enclosure and the second working area may be a rear working area facing the rear of the protective enclosure.

Furthermore, the cell side wall is preferably made in one piece, consists of an iron or aluminium alloy or of a heat-resistant polymer and may preferably include areas for the attachment of welding curtains. In addition, the side wall preferably comprises at least one inspection window, which in a particularly preferred further embodiment may also consist of a heat-resistant and UV filtering material and allows inspecting the enclosed working area. Thus, the working welder can be efficiently protected from possible damage (flying sparks, UV radiation, etc.) during robot welding operation, while at the same time being able to easily observe the welding operation and/or cutting operation through the window. In a particularly preferred embodiment, the inspection window may also be provided in a roller shutter preferably attached to the cell side wall.

Preferably, the side wall may also be firmly connected to the cell roof, preferably by a welded seam or threaded connections, and thus forms the movable framework of the protective enclosure. The aforementioned types of construction have the advantage of guaranteeing a compact, lightweight and stable form of protective enclosure. Thus, a robust and at the same time cost-effective body can be provided to protect the welder.

The cell roof may also preferably be made of a heat-resistant material, preferably metal or plastic, and may preferably include a housing for integrating additional elements.

In addition, at least one extraction opening may preferably be implemented on the cell roof so that an extraction device provided at the extraction opening, preferably integrated on the roof, can be carried along when the protective enclosure is moved. In this way, the extraction of harmful welding fumes at different working areas can be realised by a single extraction device and thus effectively implemented.

In a further, preferred embodiment, the extraction device may be connected to the compact cell (or the extraction opening) in other positions, such as externally (in the factory hall) and with a movable hose. Similarly, the extraction device may also be integrated on the underside of the cell, for example in a welding bench used as a working surface or on the cell side wall. In addition, a downward guided extraction system, such as a movable hose or a movable tube system, may preferably be used for extraction of the enclosed working space. The latter embodiment has the additional advantage that only the desired areas are extracted by a movable guide system, which can further minimise the necessary extraction power and thus the energy costs.

Preferably, at least one front roller shutter device may also be disposed at the front side and one rear roller shutter device may be found at the rear side of the protective enclosure, which provide at least one roller shutter, preferably made of metal, on a roller shutter mount, preferably integrated in the roof housing, and guide the roller shutter to close from the roof surface to the working surface and to open from the working surface to the roof surface. Furthermore, the roller shutters may preferably also comprise an integrated roller grille and/or windows or window areas (which are made of welding protection glass, for example) for observing the working area inside the protective enclosure. When the roller shutters are closed or opened, they close flush with the aforementioned side walls or with the sides of the protective enclosure, so that in a closed position of both roller shutter devices there is a space enclosed on all sides for the working area located under the protective enclosure and the open position of at least one roller shutter device allows access to the working area enclosed by the protective enclosure. This structure not only enables an efficient enclosure of the respective working area, but also simplifies the access to the latter by partially opening and closing the roller shutters.

In a particularly preferred embodiment, at least one of the roller shutter devices may also be integrated on three sides (particularly preferably on all four sides) of the above mentioned protective enclosure, wherein preferably at least one roller shutter on each of the roller shutter devices may be capable of completely closing the respective side of the protective enclosure. This enables the complete enclosure of the respective working area located under the protective enclosure, wherein the additional roller shutter device implements an improved modularity of the working areas as well as an optimised accessibility.

Furthermore, the individual roller shutters of the roller shutter devices may preferably each be opened and closed independently by a drive module and preferably comprise a safety device to prevent possible entrapment of objects or body parts. In a particularly preferred form, individual roller shutters may also be connected in a modular way in order to divide a working area into different partial working areas by opening and closing individual roller shutter combinations. This device allows a corresponding working area to be enlarged or modulated particularly effectively and quickly, whereby the workflow used can be made even more efficient. Preferably, at least one roller shutter may also be provided on the front and rear roller shutter devices, which can completely close the respective (front or rear) side of the protective enclosure for faster modulation of these partial working areas.

Preferably, the roller shutter devices also comprise at least one drive for opening and closing the roller shutter device and preferably at least one safety device for preventing pinching incidents. With these additional elements, the movement of the roller shutter can be defined even more precisely due to the precise, electrical control of the roller shutter and its safety standard can be optimised in all dimensions for use in a parallel welding operation.

In addition, the roller shutter devices can be opened and closed independently of each other, thus implementing a further improved modularity of the structure.

For moving the protective enclosure from at least one position to another position and back, in a preferred structure at least one guide rail may be attached to the lower side of the roof and rest on a fixed, motionless guide device. The guide device may preferably be controlled pneumatically or (only) with pneumatic support, so that possible wear caused by the movement of the protective enclosure and the risk of injury during the movement is minimised due to integrated sensors. Alternatively, the control of the guide device may be carried out electrically or mechanically, which can lead to a more precise or simplified movement mechanism of the protective enclosure.

In a particularly preferred embodiment of the device, the guide device is also attached to at least one static base frame so that the protective enclosure can be moved on the guide device along the base frame at least from a first position for enclosing the first working area to a second position for enclosing the second working area and back. Such an embodiment allows the shape of the compact cell to be as optimal as possible, as the geometry and size of the working areas to be protected thus depend only on the shape of the base frame. Furthermore, the base frame is preferably fixed inside the side wall of the protective enclosure during the movement of the protective enclosure from one position to another and back again, so that the important guide elements are protected during the movement, but also during the transport of the entire compact cell, in a particularly efficient way.

In particular, such a base frame enables optimal movability of the protective enclosure even with more than two working areas. For example, in a preferred embodiment of the invention, the compact cell may also comprise at least a first, a second and a third working area sequentially along a longitudinal axis, wherein the protective enclosure can continue to enclose each of the individual working areas by moving linearly along the longitudinal axis defined by the base frame and thus continue to optimally protect the welder even in more complex structures.

The guide device is further preferably configured to enable an alternating welding operation, i.e. the protective enclosure in the second position can completely enclose the second working area, wherein, for example, the first working area is made freely accessible to the welder and, when the protective enclosure is moved into the first position, the front working area becomes enclosable whereas the rear working area(s) is/are exposed. This makes it possible for the welder to work in parallel at all times in preparation for the next work step or welding piece, which also further increases the effectiveness of the welding operation. In addition, in a particularly preferred design, the walls and roller shutters of the protective enclosure may be flush with the frame of the working area in at least one position, resulting in advantageous transportability and compactness of the compact cell.

Thus, the guide device may preferably be configured in such a way that after moving the protective enclosure from at least one position to the other position, at least one working area is no longer enclosed by the protective enclosure from all sides.

Preferably, the base frame is further connected to at least one modular welding bench, preferably on both sides of the bench, wherein the base frame not only gains further stability, but the working areas used can also be further optimised. For this reason, the welding bench is also preferably provided with a perforated grid plate so that the welding bench can be used as a support for at least one of the working areas for the precise adjustment of working materials and other elements. In a particularly preferred embodiment, each working area further comprises at least one modular welding bench or plate, wherein a welding bench may comprise further elements, such as an additional welding device for the welder, drawers or a connection point to another working area, which can considerably facilitate the general welding operation within the compact cell and accelerate the production.

In addition, the modular welding bench may preferably be configured in relation to the base frame in such a way that it is enclosed from all sides in at least one position of the protective enclosure, which not only allows optimum compactness or transportability of the compact cell to be realised, but also provides improved protection for the welder.

In addition, a modular welding bench also offers the possibility to further optimise the above mentioned preferred partitioning of the working surfaces. Thus, in a particularly preferred mode of presentation, the perforated grid allows at least one further modular partition wall directed along the direction of movement of the protective enclosure to be integrated into one of the working areas and combined with at least one of the modular roller shutters of the rear or front roller shutter devices. By means of such a device, working areas can thus be divided into smaller partial working areas in the closed position of the respective roller shutter devices, which can also be enclosed on all sides. Preferably, the partition wall may also be realised by a roller shutter, so that the respective working areas can be assembled in a modular way by opening and closing the respective roller shutter.

The welding robot to be used may preferably also be positioned on the welding bench, on the side walls of the protective enclosure or the inside of the cell roof on a support or a rail connected to the above mentioned elements in at least one of the working areas. In a particularly preferred embodiment, a welding robot provided with a manipulator at at least one station and movable at least in one axis of rotation may be selected, which may preferably also be a cobot. With such a robot, it is therefore possible to carry out even complex welding tasks, wherein the perforated grids incorporated in the welding bench can make the positioning or fixing of the latter even more flexible and thus provide the welding system with further degrees of freedom.

The cobot preferably weighs less than 40 kilograms, which means that it can be used flexibly wherever it is needed, in contrast to a classic industrial robot system. While the robot is welding, the employee can withdraw and thus does not have to inhale the welding fumes. The cobot is also very easy to program. With manual guidance and operation via touch panel, teaching new tasks is possible after only a short training period. With a freedrive function, the cobot or the torch can be easily moved by hand to the position where it is to start and end. Intermediate waypoints and sections are also programmed in this way. The cobot (or collaborative robot) delivers consistently high-quality welds that require little to no rework.

In addition, cobots are technically designed so that they can work safely in the direct vicinity of humans without a protective fence. The cobot ensures the required safety in direct contact with the operator by means of a unique 6-fold force and moment monitoring system that enables flexible interaction between the robot and its environment. An advantageous cobot preferably corresponds to the collaboration type according to the technical specification ISO TS15066.

If the compact cell or cobot welding cell is equipped with additional axes (positioning device), the cobot can be taught the position points very quickly without programming knowledge by moving them manually and at the same time workpieces can be positioned in the optimum welding position by means of the additional axes and thus also processed productively on several sides. The cobot performs a precise movement of the torch and the welding system delivers the perfect seam. Preferably, the collaborative robot includes a learning mode to learn a working motion of the welding torch for processing the workpiece and a working mode to perform the working motion learned in the learning mode, the working mode enabling both welding and cutting of the workpiece.

Furthermore, the positioning of the welding robot on the side walls of the protective enclosure or the cell roof enables the welding robot to be moved by moving the protective enclosure to enclose a respective working area and to be used to process the workpiece located in the working area. Such an embodiment thus not only offers optimum compactness or space utilisation of the compact cell, as more working area can be realised on the associated welding bench through such a fastening, but also prevents any restrictions that would arise when moving the protective enclosure or through a fixed welding robot position.

Preferably, however, the guide device of the protective enclosure is at least configured with respect to the position of the welding robot in such a way that the welding robot can be enclosed from each side by the protective enclosure in the first position and preferably also by the protective enclosure in the other positions and automatically closes all sides before each welding operation. Such a design makes it possible to ensure optimum safety for the welder without impairing the movement of the protective enclosure.

In addition to a fixed mounting of the welding robot, e.g. by threaded fixings, the welding robot may preferably also be positioned on a robot guidance system, i.e. a rail or an eccentric swivel or concentric rotary axis on the welding bench or again in each case on the side wall of the protective enclosure or on the cell roof. In a very preferable embodiment, the welding robot can thus also independently move between the above mentioned, modularly defined partial working areas or switch between the respective working areas via an external control system, and thus master even complex, spatially distributed work steps. Thus, the process steps can be further optimised by the choice of the robot guidance system and additional working area can be created by the minimum area requirement (e.g. of the rotary axis).

In summary, the above mentioned features make it possible to realise a compact welding cell which, in particular due to the movable protective enclosure and the resulting alternating welding operation, not only allows optimised method steps with maximum utilisation of the working area, but also provides the best possible protection for the respective welder at every stage of the method. In this context, the protective cover, as a combination of at least one side wall and a roof, preferably initially functions primarily as a primary protective device for the integrated elements, wherein roller shutter devices mounted on roller shutter mounts on the inside of the protective enclosure can completely enclose a working area located under the protective enclosure and thus seal off the welder from harmful effects during welding operations. The protective enclosure is further supported on a pneumatically approachable guide on a base frame so that it can be moved between a first position for enclosing a first working area and at least a second position for enclosing a second working area. In such a design, optimal alternating welding, as mentioned above, can be realised. Furthermore, the guide can preferably be designed in such a way that the welding robot positioned in at least one of the working areas and controllable by several degrees of freedom can be enclosed from all sides at least in one position, which ensures not only the best possible protection but also the largest possible working area for the robot. Further features, such as the modulable welding bench, also realise an individual adaptability required for the respective welding process, which can be further maximised by a possible division of the working areas into partial working areas by a combination of modulable roller shutter devices and partition walls.

Such a compact cell thus offers the best possible individualisation with maximum compactness and transportability. In addition, the compact cell may preferably be a mobile compact cell comprising at least one fork pocket for transport, so that in particular in one of the two positions of the protective enclosure the compact cell can be transported by the fork pocket with a lift truck, thus enabling an even easier transport of the compact cell. Preferably, wheels may also be used on the underside of the compact cell.

### SHORT DESCRIPTION OF THE FIGURES

FIG. 1A: shows a first view of the compact cell according to the invention with the protective enclosure in the first position.

FIG. 1B: shows a side view of the compact cell.

FIG. 1C: shows a side view of the compact cell with the protective enclosure in the second position.

FIG. 2A: shows a view of the compact cell with the protective enclosure in the first position and one side of the compact cell visible.

FIG. 2B: shows the view of the compact cell of FIG. 2A with the protective enclosure in the second position.

FIG. 3A: shows a top view of the compact cell without roof structure and the protective enclosure in the first position.

FIG. 3B: shows the top view of FIG. 3A with the protective enclosure in the second position.

FIG. 4A: shows a three-dimensional view of an embodiment of the compact cell with several rolling shutters and partition walls and the protective enclosure in the first position.

FIG. 4B: shows the three-dimensional view of the embodiment of FIG. 4A with the protective enclosure in the second position.

FIG. 5A: shows a top view of the compact cell of FIG. 4A without the roof structure and the protective enclosure in the first position.

FIG. 5B: shows the top view of the compact cell of FIG. 5A with the protective enclosure in the second position.

FIG. 6A: shows a sectional view of an embodiment along the side axis of the compact cell with roller shutter device.

FIG. 6B: shows a detailed view of the guide device of FIG. 6A.

FIG. 6C: shows a view of a representation of the compact cell without protective enclosure.

FIG. 7: shows the top view of a further embodiment of the compact cell without roof structure with a linear guide rail of the welding robot.

FIG. 8A: shows a cross-sectional view of the left side of a further embodiment of the compact cell with the welding robot on an eccentric axis and the protective enclosure in the first position.

FIG. 8B: shows the cross-sectional view of FIG. 8A with the protective enclosure in the second position.

FIG. 9A: shows a cross-sectional view of the left side of a further embodiment of the compact cell with several roller shutters and the protective enclosure in the first position.

FIG. 9B: shows the cross-sectional view of FIG. 9a with the protective enclosure in the second position.

FIG. 10: shows a front view of a further embodiment of the compact cell with the welding robot on a connecting device attached to the underside of the cell roof.

FIG. 11: shows a three-dimensional view of the embodiment of FIG. 10 with the protective enclosure in the second position.

FIG. 12A: shows a front view of a further embodiment of the compact cell with the welding robot on a linear guide rail attached to the underside of the cell roof.

FIG. 12B: shows a three-dimensional view of the right side of the embodiment of FIG. 12A with the protective enclosure in the second position.

FIG. 12C: shows a cross-sectional view of the right side of the embodiment of FIG. 12A with the protective enclosure in the first position.

FIG. 13A: shows a side view of a further embodiment of the compact cell with three working areas positioned one behind the other and the protective enclosure in the second position.

FIG. 13B: shows a side view of the embodiment of the protective enclosure of FIG. 13A.

FIG. 13C: shows a three-dimensional view of the embodiment of the compact cell of FIG. 13A.

FIG. 13D: shows a three-dimensional view of a further embodiment of the compact cell with three working areas positioned one behind the other and a manipulator mounted on the working areas and the protective enclosure in the third position.

FIG. 13E: shows a three-dimensional view of the embodiment of the compact cell of FIG. 13D with the protective enclosure in the second position.

FIG. 13F: shows two front views of the embodiment of the compact cell of FIG. 13D with the protective enclosure in the third (top) and second (bottom) position.

FIG. 14A: shows a front view of the embodiment of the compact cell of FIG. 13A with the protective enclosure in a third position.

FIG. 14B: shows a three-dimensional representation of the embodiment of the compact cell of FIG. 14A.

### DETAILED DESCRIPTION OF PREFERRED EMBODIMENTS OF THE PRESENT INVENTION

In the following, embodiments of the present invention are described in detail with reference to exemplary figures. The features of the embodiments may be combined in whole or in part, and the present invention is not limited to the described embodiments. Furthermore, insofar as possible, reference signs with the same name refer to the same feature of the invention across all figures.

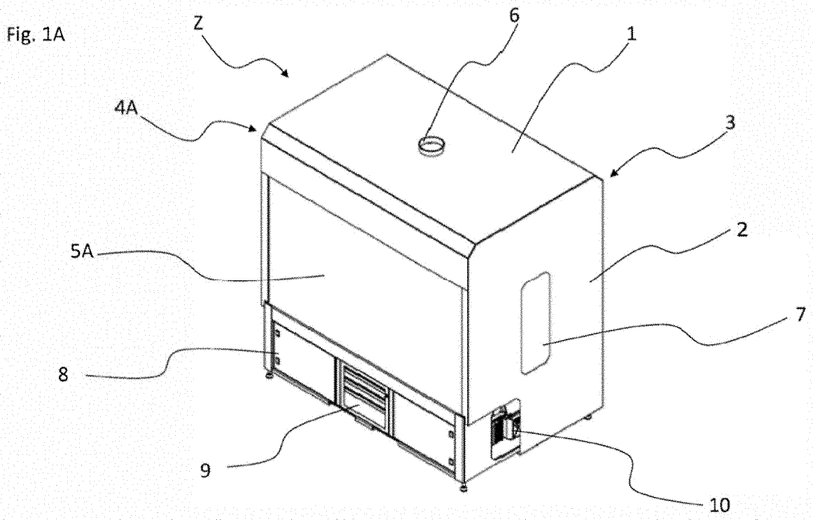

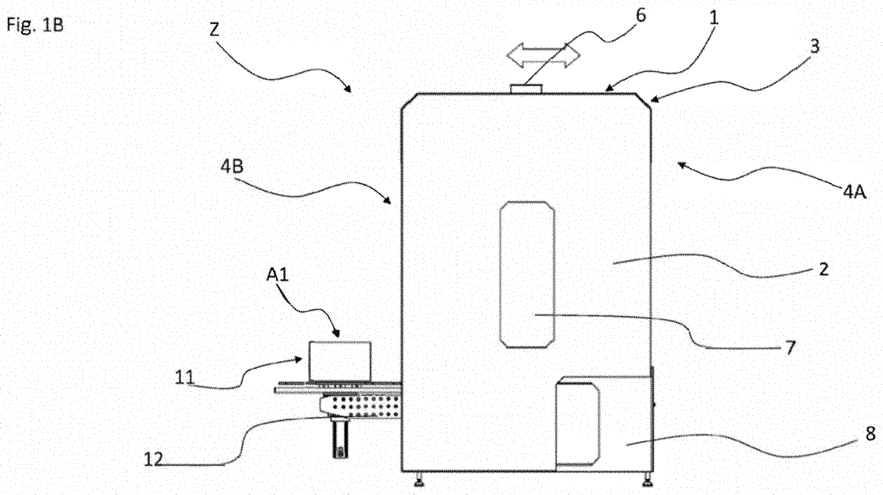

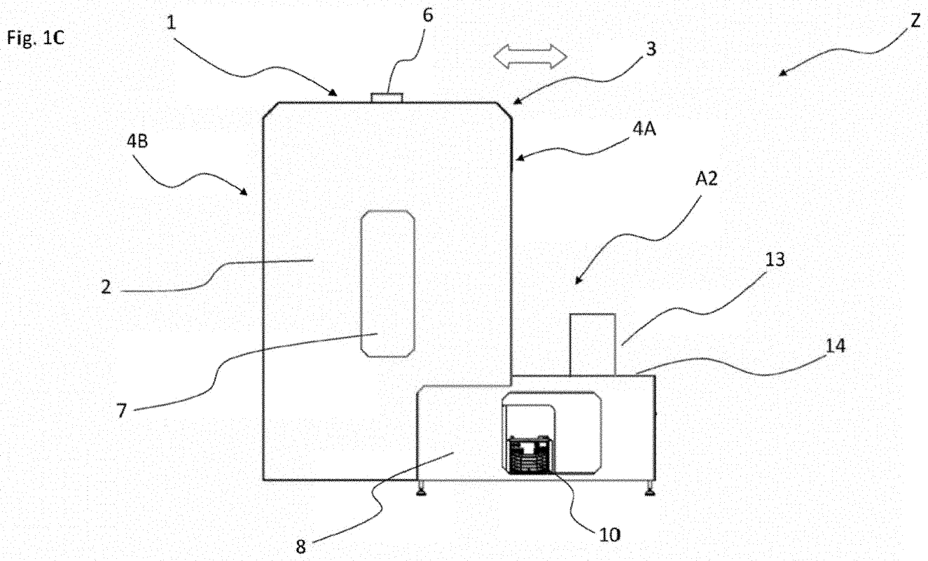

FIG. 1A shows the externally visible form of a first embodiment of the present compact cell Z together with the protective enclosure 3. The protective enclosure 3 comprises a roof 1 and the side walls 2, which are firmly connected to each other, and encloses a modular welding bench 8, which can be used as a working surface. The side walls 2 of the protective enclosure 3 are preferably provided with at least one window 7 for observing the welding operations inside the compact cell Z and the roof 1 includes an extraction opening 6 through which harmful welding fumes can be discharged by means of an extraction device.

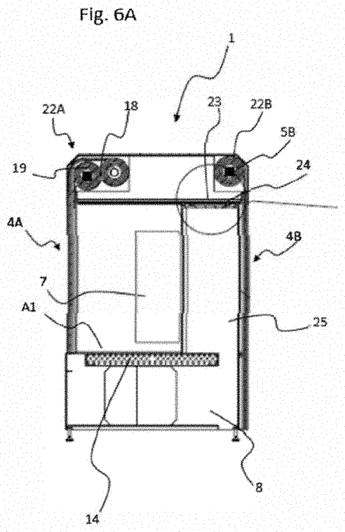

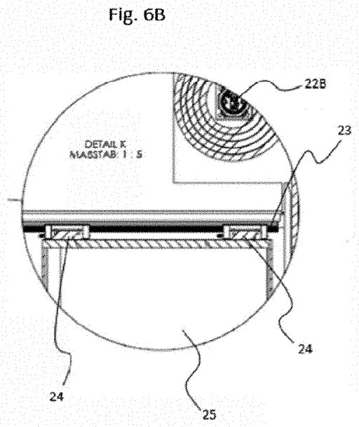

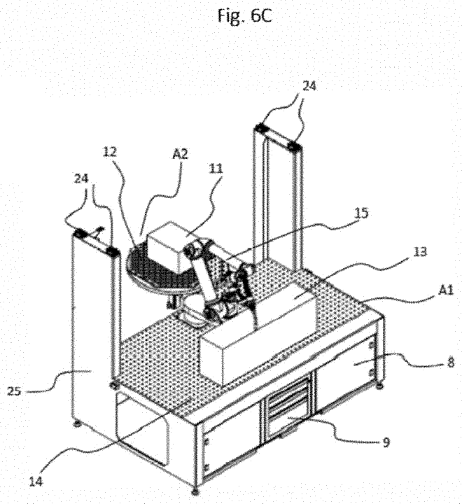

Furthermore, roller shutter devices 22A, 22B (not shown in the figure, see e.g. FIG. 6A) are integrated at the front and rear sides 4A, 4B of the protective enclosure 3, which allow closing the front side 4A and protective enclosure 3 flush with the side walls 2 by a front roller shutter 5A and its rear side 4B by a rear roller shutter 5B (not shown in this figure). This design allows enclosing a working area located under the protective enclosure 3 from all sides. However, a preferably integrated safety device (not shown) prevents the movement of the roller shutters 5A, 5B when elements under or between them are detected, so that damage or injuries due to pinching incidents are prevented during regular operation.

The modulable welding bench further includes a drawer device 9 suitable for tools and materials, as well as an additional welding device 10, whereby the welding operations performed in the compact cell Z can be further optimised.

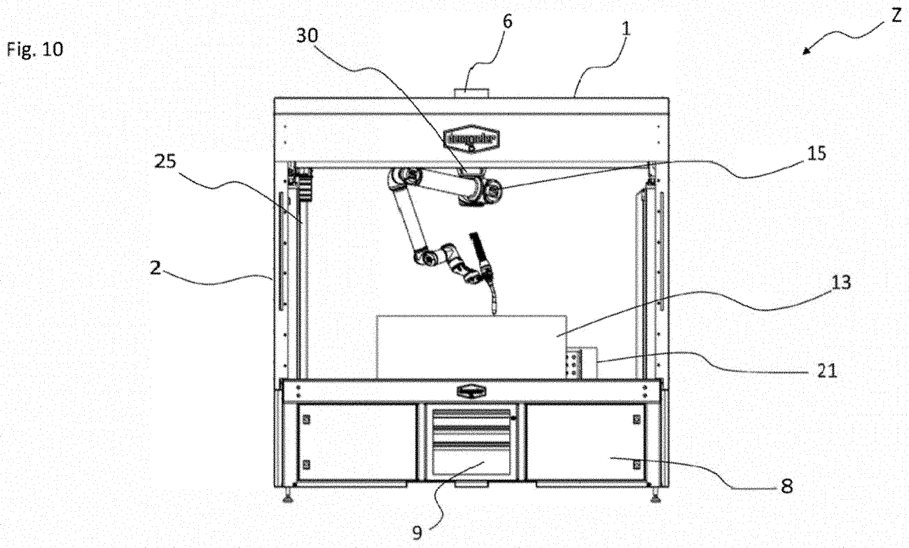

FIGS. 1B and 10 show the possible positions of the protective enclosure 3 and the corresponding working areas A1, A2. In FIG. 1B, the protective enclosure 3 is disposed in the first position, which means that the front part of the modular welding bench 8, together with the first working area A1, can be enclosed on all sides by the protective enclosure 3, thus forming a welding area that is safe for the welder. In this case, the movement of the protective enclosure 3 is configured in such a way that, in the first position of the protective enclosure 3, a rear working area A2 is completely exposed and can thus be used by the welder to prepare or individually process a first workpiece 11, parallel to the welding operation inside the protective enclosure 3. In this embodiment, the rear working area A2 also comprises an adjustable worktop 12 provided with grid holes, which has been firmly connected to the welding bench 8 for an optimised workflow.

FIG. 10 shows the embodiment of the compact cell Z already shown in FIG. 1B, wherein the protective enclosure 3 has now been moved into the second position. In this case, the rear working area A2 is disposed inside the protective enclosure 3 and can thus be enclosed from all sides by closing the roller shutters 5A, 5B on the front 4A and rear side 4B of the protective enclosure 3. In contrast, in this position of the protective enclosure 3, the front working area A1 is exposed and can thus be used by the welder to process or remove a second workpiece 13, wherein the first workpiece 11 in the enclosed working area A2 can be processed in parallel by a welding robot inside the protective enclosure 3. This change of position of the protective enclosure 3 thus makes it possible to realise an optimised alternating welding operation in which a welder can carry out or prepare a next work step at one of the working areas at any time in addition to the welding operation carried out by the robot. Further integrations, such as the welding device shown in this embodiment inserted in the welding bench 8 or a perforated grid inserted in the tabletop 14, also allow the respective working area to be further individualised. Furthermore, the designation of the first and second positions is not limited to the exemplary assignment of the exemplary embodiment. A reversed definition between front and back or first and second position is also possible. Preferably, a manipulator can be freely positioned at different positions on the perforated grid table (tabletop 14). Preferably, the collaborative robot may also be provided on the perforated grid table for easy positioning. The perforated grid system is preferably unthreaded and can thus ensure easy positioning.

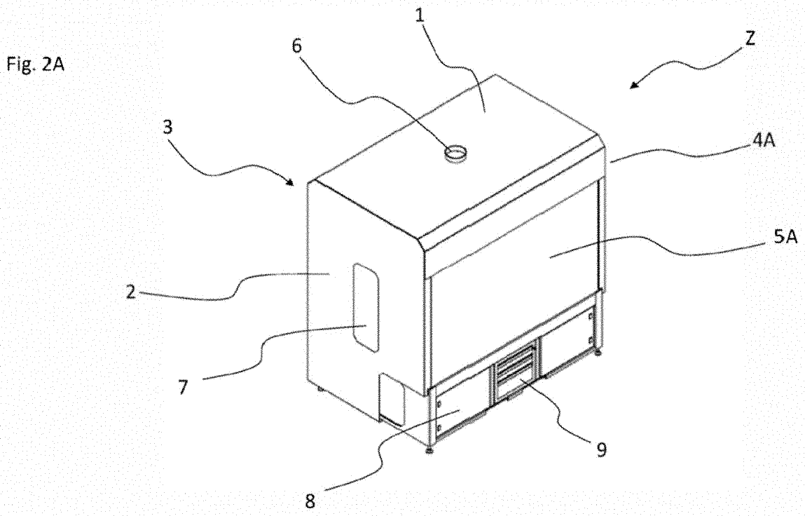

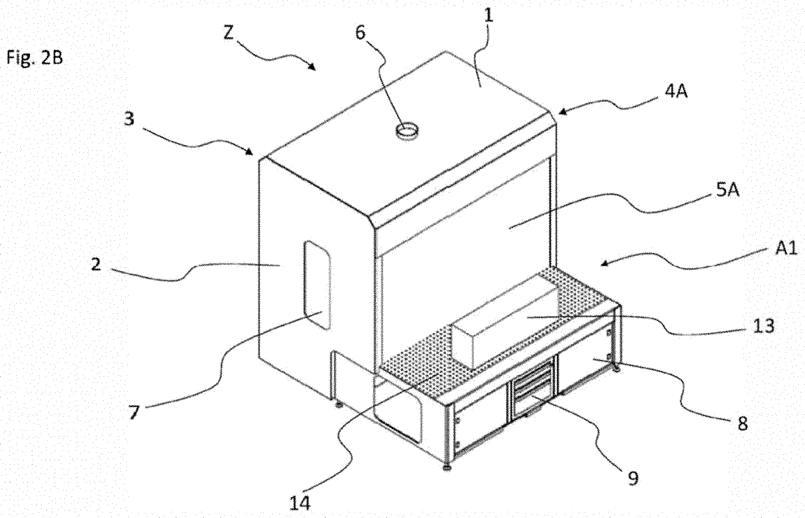

FIGS. 2A and 2B show the advantages of the movable protective enclosure 3 in a three-dimensional representation rotated to the left. FIG. 2A shows the protective enclosure 3, also called the protective cover, in the first position. The closed front roller shutter 5A, which is flush with the cell sides 2 and the welding bench 8, makes it possible to provide an almost cuboid structure which is best suited for transport or for integration into an already existing system.

In FIG. 2B, the protective enclosure 3 is shown in the second position, exposing the front working area A1. The perforated grid tabletop 14 inserted in the modulable welding bench 8 can be used to position the workpiece 13 to be processed in the correct shape or to integrate any elements to support the welding operation. The cavity that is also created between the tabletop 14 and the base of the table 8 can be used to insert further devices into the first working area A1 and thus further optimise the workflow. The protective enclosure 3 in the second position may further enclose possible openings to this cavity so that integrated elements are optimally protected.

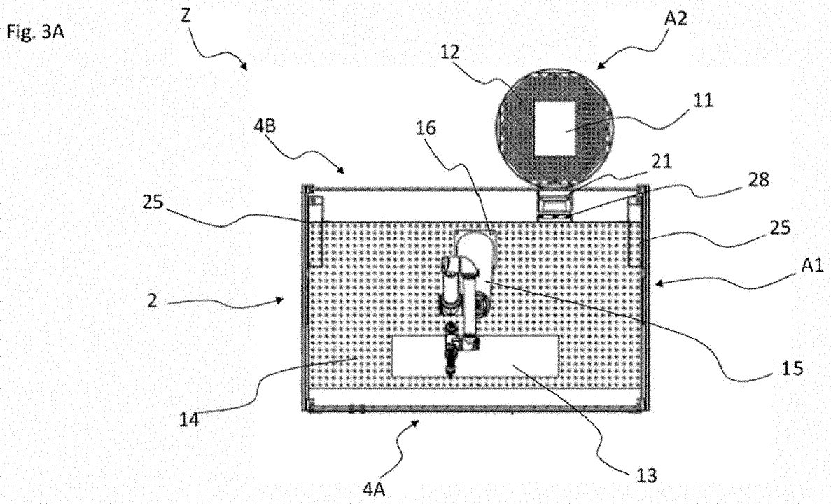

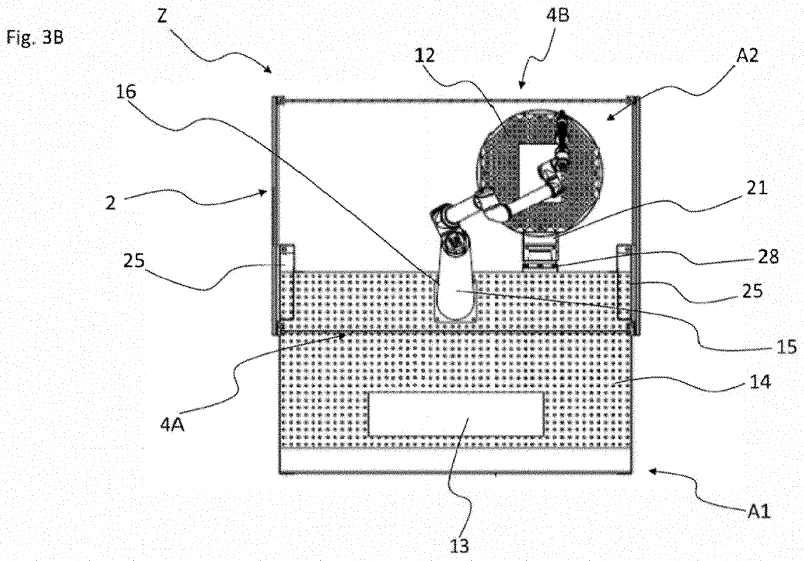

FIGS. 3A and 3B show the internal and connecting elements of the compact cell Z in an embodiment of the welding robot fixation. In FIG. 3A, which shows the compact cell Z from above with the protective enclosure 3 in the first position, the welding robot 15 is mounted on a support 16 fixed to the perforated grid of the welding bench 8, so that the welding robot 15 can be moved in the first working area A1 by manipulators positioned on various arm joints, but its base remains fixed to a position on the table 8. Furthermore, the adjustment of the welding plate 12 of the second working area A2 to the welding bench 8 is carried out with the aid of a movable swivel arm 21, which can be fixedly attached to the table 8 with a connecting element 28 for precise positioning. By means of such a device, the worktop 12 of the second working area A2 can be exchanged modularly to the welding bench 8 and folded or removed for transport purposes, which further increases the compactness and efficiency of the compact cell Z.

FIG. 3B shows further the embodiment of FIG. 3A, wherein the protective enclosure 3 has been moved to the second position. In this case, the protective enclosure 3 is configured in such a way that in this position it can enclose the second working area A1 and the welding robot 15 together with the support 16 continues to be located in the protective enclosure 3. In this way, an optimum protection of the welding person can be realised during the movement of the protective enclosure 3 as well as in the two end positions. The degrees of freedom of movement of the welding robot 15 also allow free repositioning of the welding head from the second workpiece 13 of the first working area A1 to the workpiece 11 of the second working area A2, thus ensuring a simplified changeover of the working operation from one working area to another.

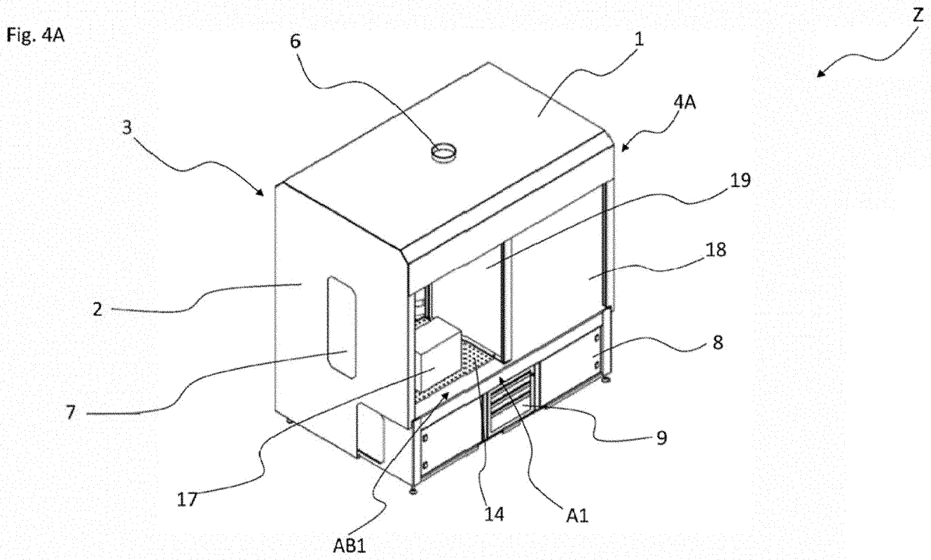

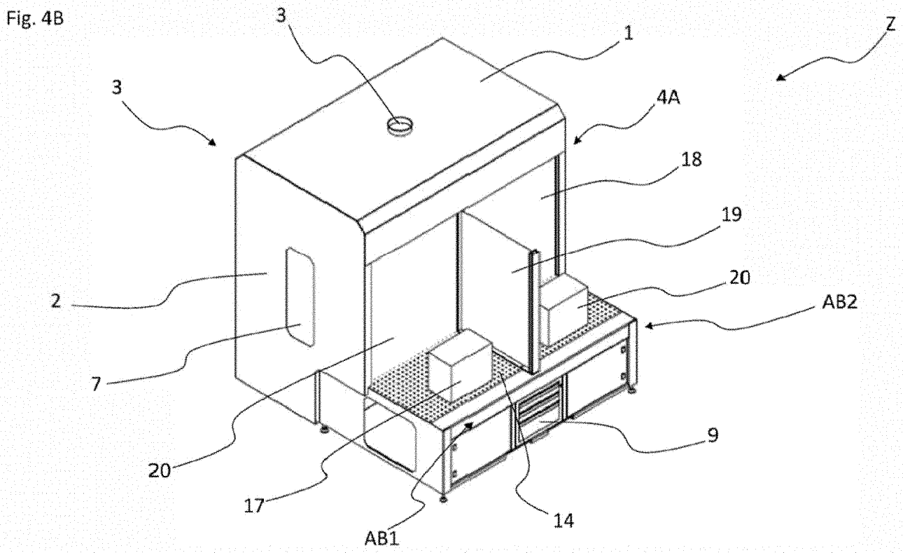

FIGS. 4A and 4B show a further embodiment of the compact cell Z in which the first working area A1 can be divided into modulable partial working areas AB1 and AB2 by introducing independently modulable roller shutters 18, 20 and a partition wall 19. By implementing such a construction, the working area to be used by the welding robot 15 or the welder can be further individualised, which leads to an optimal utilisation of the respective working areas A1, A2.

In the illustration shown in FIG. 4A, in which the protective enclosure 3 can again be seen in the first position, the front side of the protective enclosure 3 includes, for example, two preferably equally sized, independently modulable roller shutters 18, 20, wherein only the left modulable roller shutter 18 is closed and is modified by an additional partition wall 19, which can also be realised by a roller shutter, inserted centrally in the welding bench 8, to form a separated, additional partial working area AB2 of the welding robot. The opened, right-hand roller shutter 20, on the other hand, enables the welder to work in parallel, e.g. on a third workpiece 17, in the right-hand partial working area AB1, whereby in this embodiment, in the first position of the protective enclosure 3, work on both sides (on the partial working area AB1 and the rear working area A2), i.e. parallelisation of several welding operations at the same time, is enabled. Furthermore, in this embodiment, the individual modulable roller shutters 18, 20 and partition walls 19 can be connected, separated again and opened and closed independently of each other, so that optimum access to individual partial working areas AB1, AB2 or working areas A1, A2 is guaranteed.

FIG. 4B again shows the embodiment of 4A with the protective enclosure 3 in the second position, wherein in this case both the left-hand roller shutter 18 and the right-hand modulable roller shutter 20 are closed. The partition wall 19, which continues to exist, repeatedly forms two partial working areas AB1, AB2, which, however, are clearly delimited from the corresponding robot working area in this case by the enclosure of the second working area A2 together with the welding robot 15 by the protective enclosure 3. Thus, in this embodiment, even two or, with a corresponding number of partition walls, more partial workplaces can be realised for welding operations to be carried out by one welder.

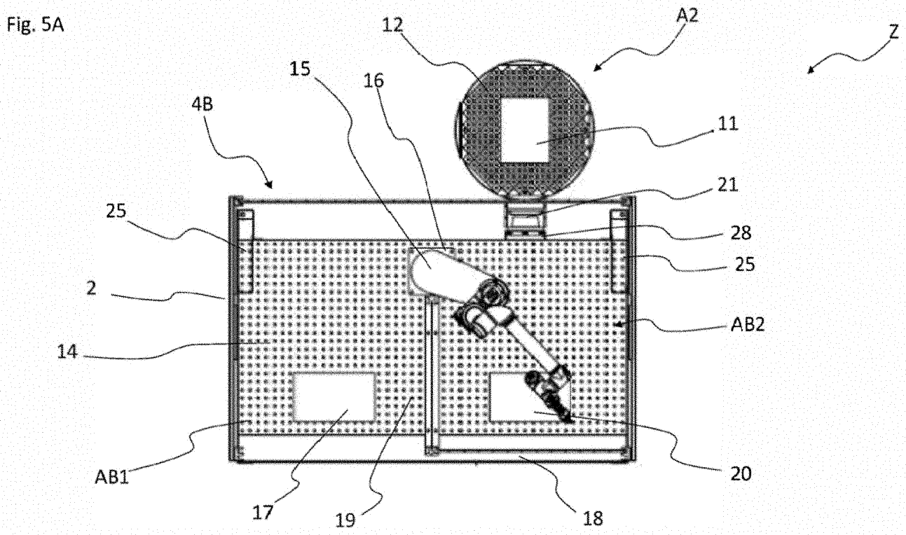

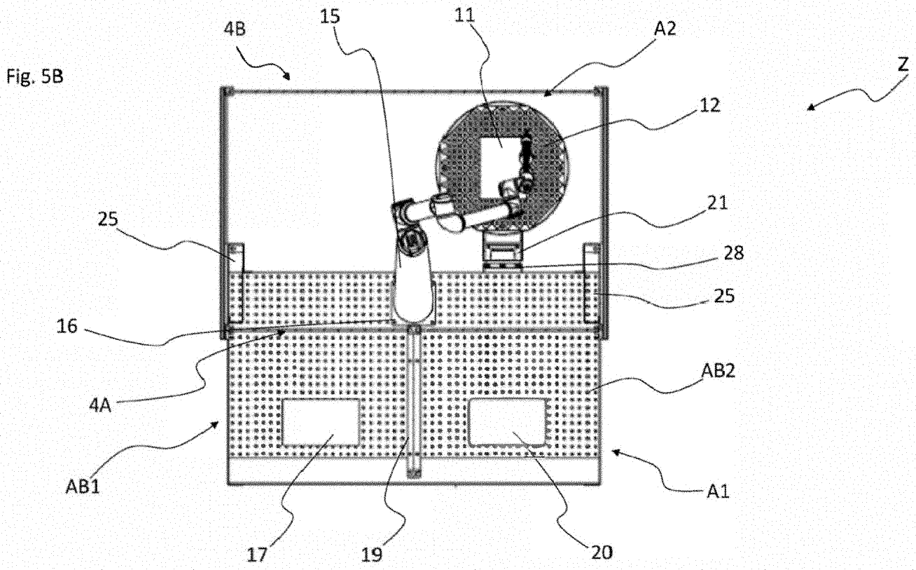

FIGS. 5A and 5B specify, as a top view of the embodiment shown in FIGS. 4A and 4B, the position and function of the welding robot 15 with respect to the aforementioned modular roller shutters 18, 20 and partition wall 19.

FIG. 5A shows a welding robot 15 together with a support 16 according to the functions as previously mentioned which has been positioned in the roller shutter constellation illustrated in FIG. 4A. The support 16 of the welding robot 15 is attached to the tabletop 14 in such a way that between the welding robot 15 and the partition wall 19 there is the smallest distance at which the welding robot can nevertheless reach the entire space of the partial working area AB2 enclosed by the partition wall 19 and the left-hand roller shutter 18. Similarly, the embodiment shown may also be designed in such a way that the welding robot 15 can move between the two partial working areas AB1, AB2, with the partition wall 19 remaining in place to protect the welder on the partial working area side not currently used by the welding robot 15 throughout all welding operations. In this case, it is thus possible to implement an extremely compact alternating welding method that can only be used on one side, in which the welder and the welding robot 15 can continuously alternate between the first AB1 and the second partial working area AB2. Such a method is advantageous, for example, if another welding operation is being prepared at the same time at the second working area A2 and thus the protective enclosure 3 cannot be moved from the first to the second position.

FIG. 5B shows the individual modification of the welding operation using the same welding robot 15 introduced in the embodiment shown by FIG. 4B. Since the welding robot 15 can weld independently in the second working area A2 and workpieces 11, 13, 17 can be exchanged just as independently by different welders by opening and closing the modular roller doors 18, 20, such a device, in particular the partition wall 19 introduced in the front working area A1, also allows a 2-man alternating welding system to be implemented without any problems.

FIG. 6A, which shows a lateral cross-section of the compact cell Z with the protective enclosure 3 in the first position, also shows the roller shutter devices 22A, 22B for opening and closing the modular roller shutters 18, 20 located at the front 4A and the roller shutter 5B of the protective enclosure 3 located at the rear 4B, according to the embodiment shown in FIGS. 4A, B and 5A, B. In this case, the respective roller shutters 18, 20, 5B are initially attached to a roller shutter mount V1, V2, V3 integrated in the roof 1 or in the cavity structures 29A, 29B of the roof 1, so that they can be stored as protected as possible during the movement of the protective enclosure 3 or the general welding process. A motor (not shown in the FIG. with a control unit linked to the roller shutter devices 22A, 22B controls the opening and closing of the roller shutters 18, 20, 5B.

FIG. 6A also shows the guide structure used to move the protective enclosure 3, which is also shown enlarged in FIG. 6B. For moving the protective enclosure 3 in a precise manner, two linear guide rails 23 are attached along the front axis of the protective enclosure 3 to the underside of the roof 1 or on the underside of the above mentioned cavity structure frame, wherein the length of the guide rails 23 defines the travel length of the associated protective enclosure 3. In addition, the same guide rails 23 are each seated on two pneumatically controllable guide devices 24, which move the protective enclosure 3 in the respective direction via the guide rail 23 in order to move the protective enclosure 3 from the first to the second position and back. For improving the stability of the movement mechanism, the respective guide devices are also firmly connected to a base frame 25 and, via a further connection of the base frame 25 to the respective side wall of the welding bench 8, also on both sides to the latter welding bench 8. Such a structure can, in particular, optimally stabilise the process of the protective enclosure 3 while maintaining the compactness of the compact cell Z due to the base frame 25 fitting closely to the welding bench 8,

In FIG. 6C, which shows the embodiment of FIGS. 1 to 3 of the compact cell Z in three-dimensional view and without protective enclosure 3, the structure of the base frame 25 is also shown in more detail. In this case, the base frame 25 is firmly connected to the respective outer sides of the welding bench 8 on both sides and forms beam structures at the rear ends of the welding bench 8, which rest on the rear corners of the welding bench 8 for additional stabilisation and define the height of the respective protective enclosure 3. Accordingly, on the upper ends of the beam structure, the pneumatic guide devices 24 for moving the supported protective enclosure 3 are mounted, so that when the guide rail 23 of the protective enclosure 3 is put in place, the movement of the latter further benefits from the stability of the base frame 25.

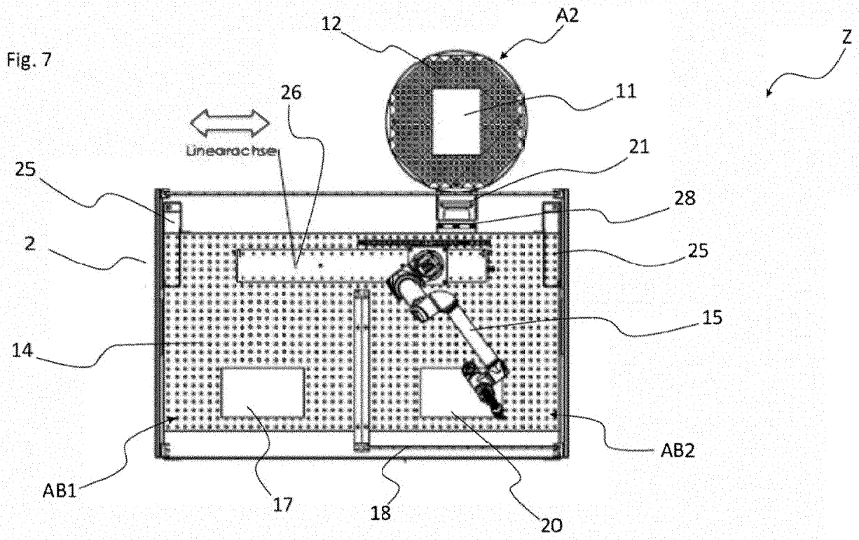

FIG. 7 shows another embodiment of the compact cell Z in top view, with the protective enclosure 3 shown in the first position and provided with the roller shutter structure already illustrated in FIGS. 4A and 5A respectively. In particular, in this case, the welding robot 15 is adjusted on a linear guide rail 26 parallel to the longitudinal axis of the welding bench 8, so that it can move between the two partial working areas AB1, AB2 of the first working area A1 in a simplified manner and reach the individual areas of the partial working areas AB1, AB2 or workpieces 13, 17 in an improved manner. In addition, the support 30 of the welding robot 15, which is connected to the guide rail 26, is rotatably mounted, whereby an equally simplified approach to the second working area A2 or the workpiece 11 mounted there can be realised in the event of a change of position of the protective enclosure 3. A control unit (not shown) connected to the motor of the guide rail 26 also enables a programmable workflow of the welding robot 15.

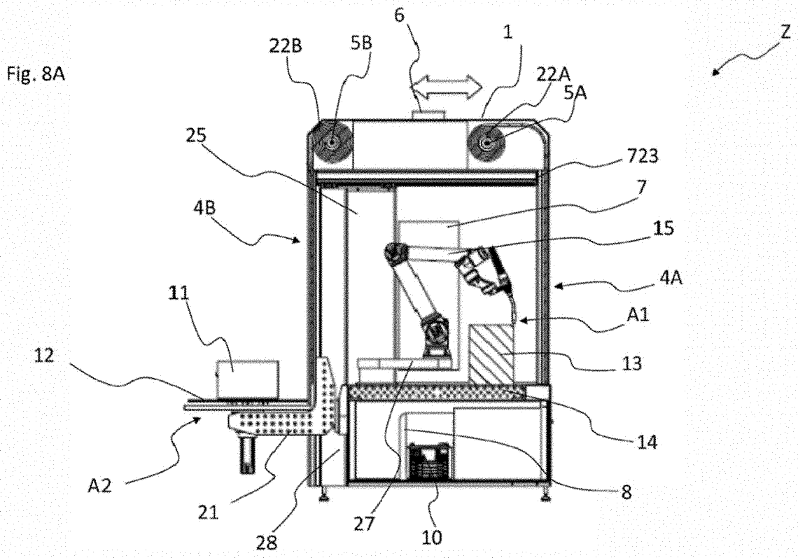

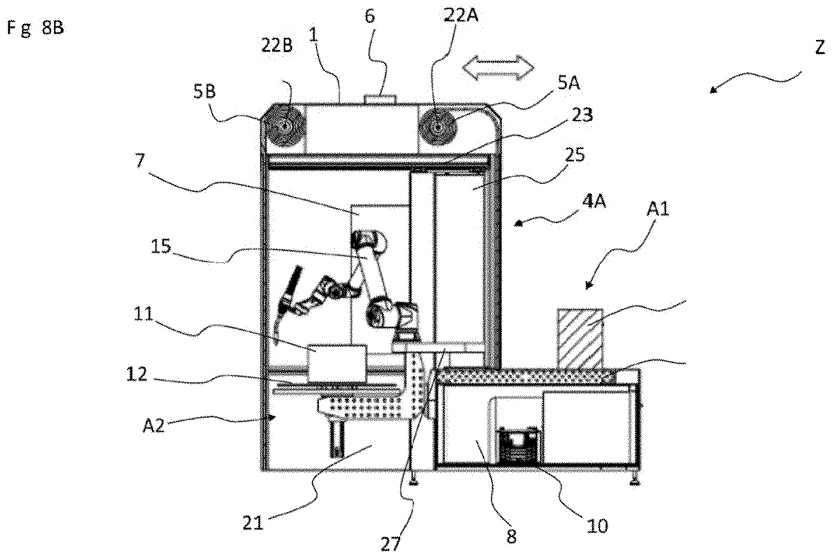

FIGS. 8A and 8B also show a further embodiment of the welding robot support 27 within a side view of the embodiment of the protective enclosure 3 already shown in FIGS. 1-3, the protective enclosure 3 remaining in the first position in FIG. 8A and in the second position in FIG. 8B. In this embodiment, the welding robot 15 is adjusted on an eccentrically mounted rotary axis support 27 attached to the welding bench plate 14, so that the welding robot 15, as an additional degree of freedom, can also be moved in the direction of the front or rear side 4A, 4B of the protective enclosure 3 and can thus be moved even in more precise and simplified manner to the respective workpiece 11, 13. Similarly, compared to a fixed, linear guide rail 26, as shown in FIG. 7, the working surface to be used can be used even more effectively with the aid of an eccentric rotary axis 27, which optimises the embodiment shown even further compared to those shown previously.

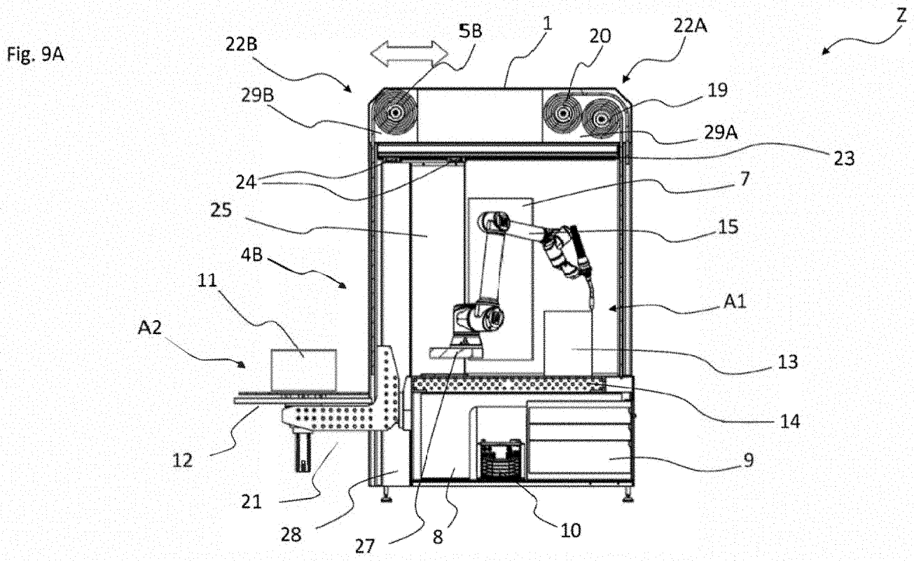

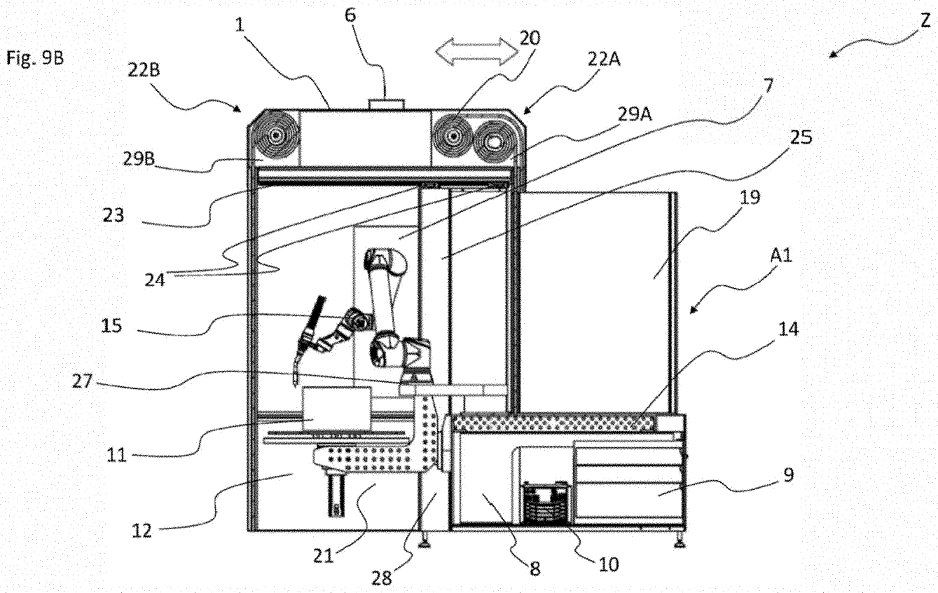

FIGS. 9A and 9B also show the embodiment of the welding robot support 27 shown in FIGS. 8A and 8B in the embodiment of the protective enclosure 3 provided with modular roller shutters 18, 20, as already illustrated in FIGS. 4A, B and 5A, B, FIG. 9A showing the corresponding protective enclosure 3 in the first position and FIG. 9B showing the same in the second position. In this case, the high modulability of the working area division by the individually positionable roller shutters 18, 20, 5B is combined with the precise control of the welding robot 15 to the workpieces 11 by the eccentrically mounted support rotary axis 27. Furthermore, none of the embodiments shown interferes with the movement of the protective enclosure 3 in the direction of the first or second position, which equally demonstrates the high modulability of the invention shown.

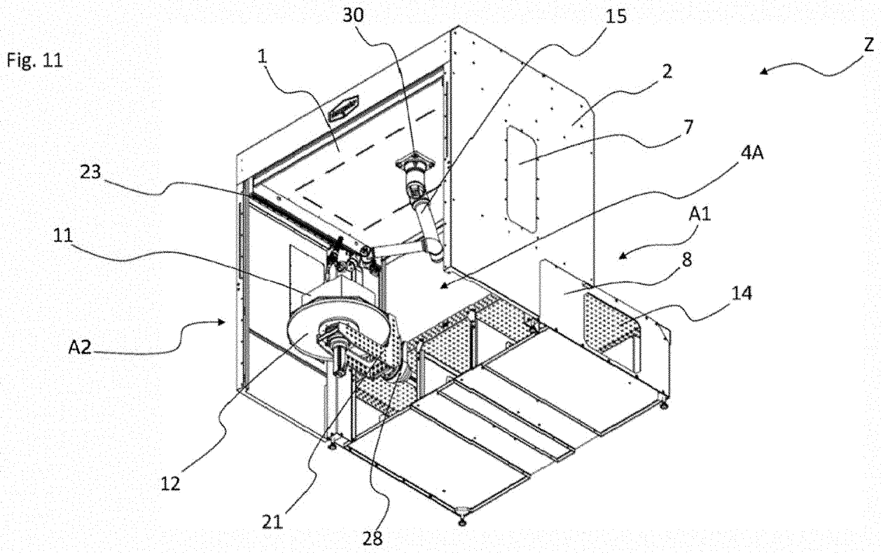

FIGS. 10 and 11 describe a further embodiment of the compact cell Z in which, within the embodiment of the protective enclosure 3 already shown in FIGS. 1 and 2, the welding robot 15 can be positioned above the welding bench by means of a connecting device 30 permanently attached to the cell roof 1.

FIG. 10 shows a front view of the above mentioned embodiment, wherein in particular the positioning of the welding robot 15 above the workpiece 13 to be processed ensures improved accessibility of the latter to the welding robot 15 and thus the precision of the welding operations involved can be further optimised. In addition, this embodiment offers the advantage that the welding robot 15, by being attached to the movable protective enclosure 3, can be moved along with the protective enclosure 3, whereby not only any restrictions on the movement of the protective enclosure around the position of a fixed welding robot 15 can be circumvented, but the welding robot 3 can also be brought even closer to the respective workpiece 11, 13, 17 with the aid of a control unit attached to the protective enclosure 3.

FIG. 11 also shows the embodiment described in FIG. 10 in a three-dimensional representation led from the bottom of the compact cell Z. In particular, the position of the connecting device 30, at which the welding robot 15 is connected to the cell roof 1, is once again clarified in more detail in this form of representation. Furthermore, it can be seen that by attaching the welding robot 15 to the protective enclosure 3, more working surface can be realised on the welding bench 8, which further optimises the work-to-cell area ratio of the compact cell Z.

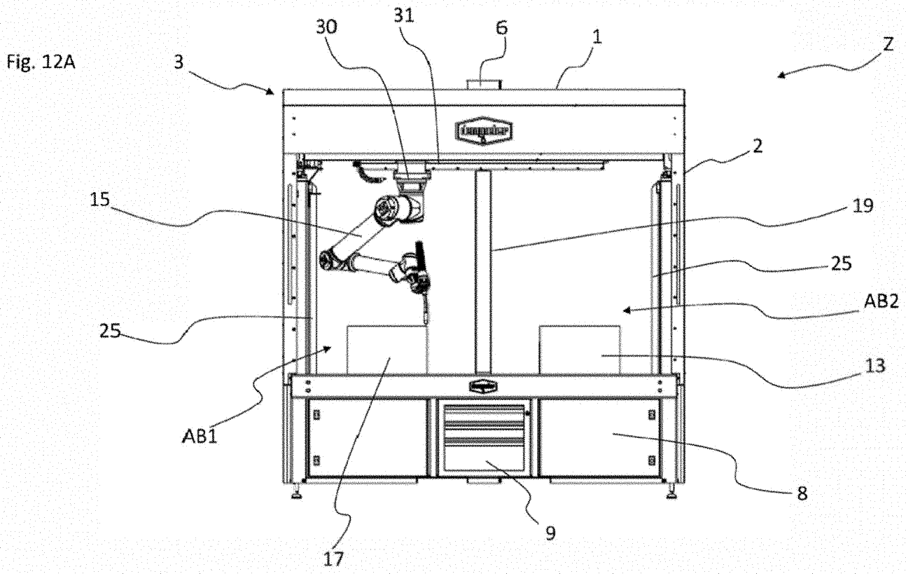

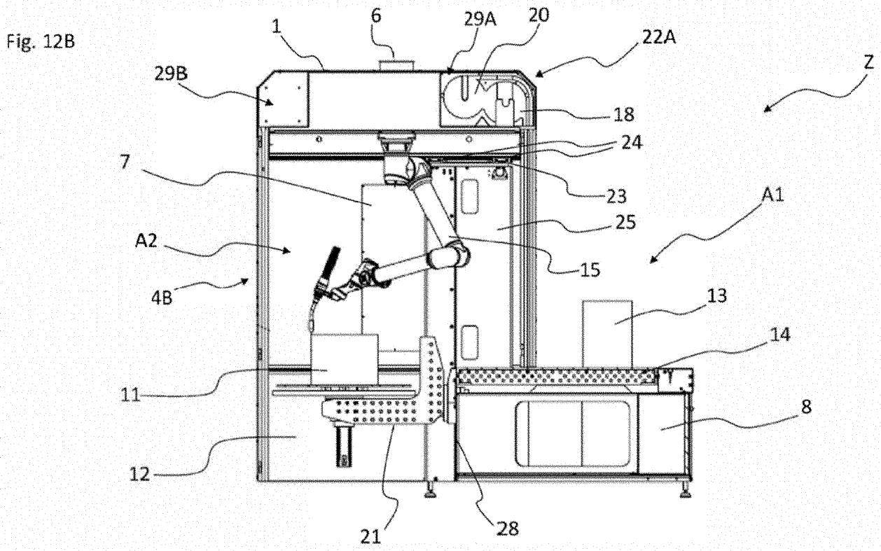

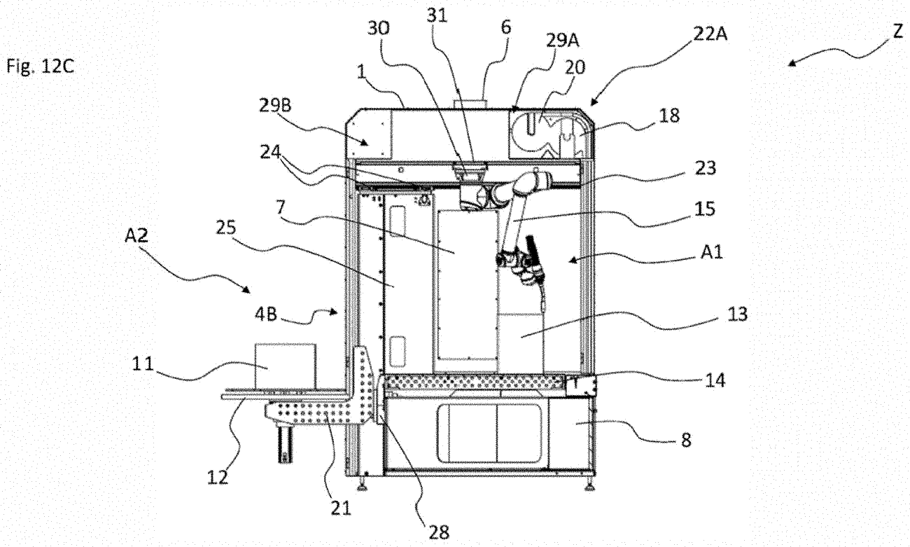

FIGS. 12A-C describe a further embodiment of the welding robot positioning in which the welding robot 15 is additionally connected via a connecting device 30 to a linear guide rail 31 attached to the roof of the protective enclosure 3 and combined with the embodiment of the protective enclosure 3 together with the welding bench 8 already shown in FIGS. 4 and 5.

FIG. 12A shows the front view of this compact cell Z, wherein the welding robot 15 can be moved between the two partial working areas AB1, AB2 via the linear guide rail 31, which is aligned parallel to the front roller shutter, and thus optimally reaches the workpieces 13, 17, which are separated from each other by the partition wall 19. In addition, the positioning of the welding robot 15 to the cell roof 1 of the protective enclosure 3 also results in the advantages that the working surfaces of the partial working areas AB1, AB2 existing on the welding bench 8 are not additionally reduced in size by the welding robot 15 or the corresponding guide rail 31, and that the welding robot 15 can be moved even more precisely to the respective workpiece by moving with it during the movement of the protective enclosure 3. FIGS. 12B and 120, on the other hand, describe a lateral cross-section of the embodiment of the compact cell Z already shown in FIG. 12A, wherein FIG. 12B shows the protective enclosure 3 in the second position and FIG. 120 shows the same device with the protective enclosure in the first position. In addition to the advantages already mentioned, it is particularly apparent here that the movement of the protective enclosure 3 in this embodiment is defined by the geometry of the base frame 25 or the size of the guide rail 23 and thus has no further restrictions (e.g. a maximum travel length due to elements fixed on the welding bench 8). Thus, larger compact cells Z or even compact cells Z which can be modelled in a geometrically free manner could also be realised by this embodiment.

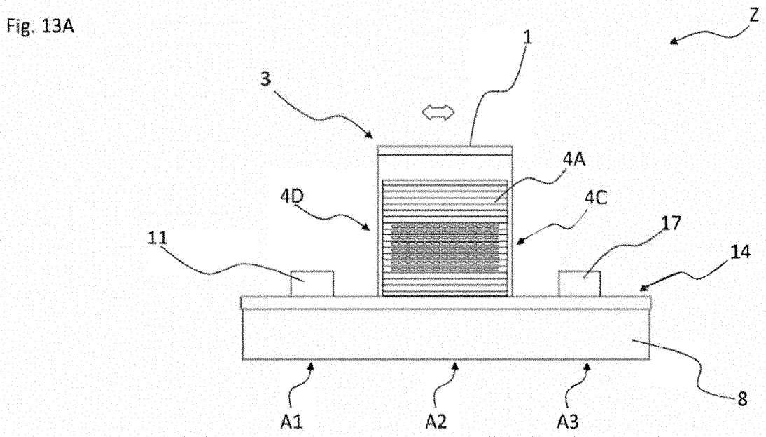

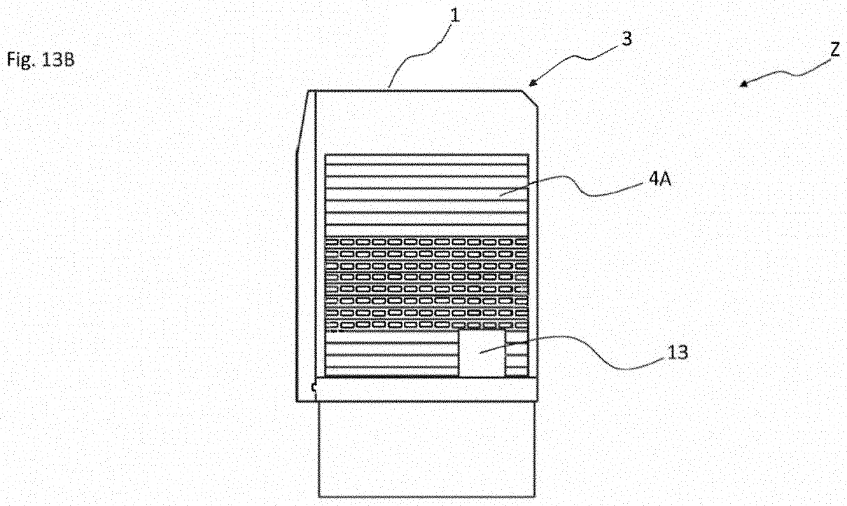

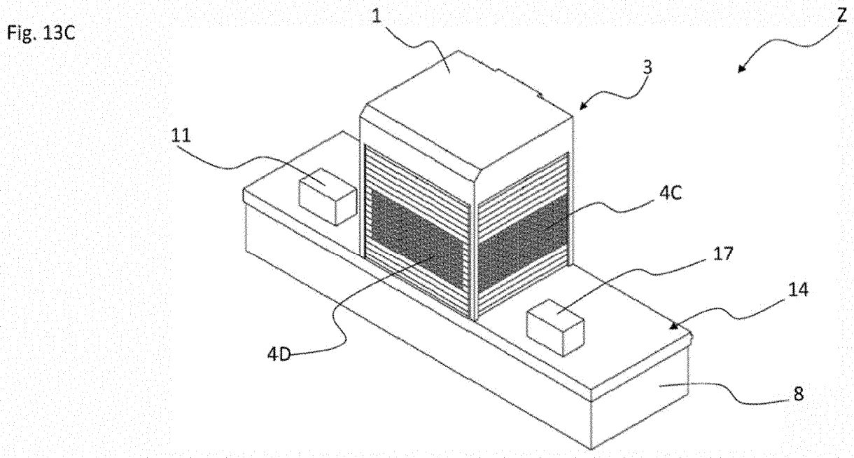

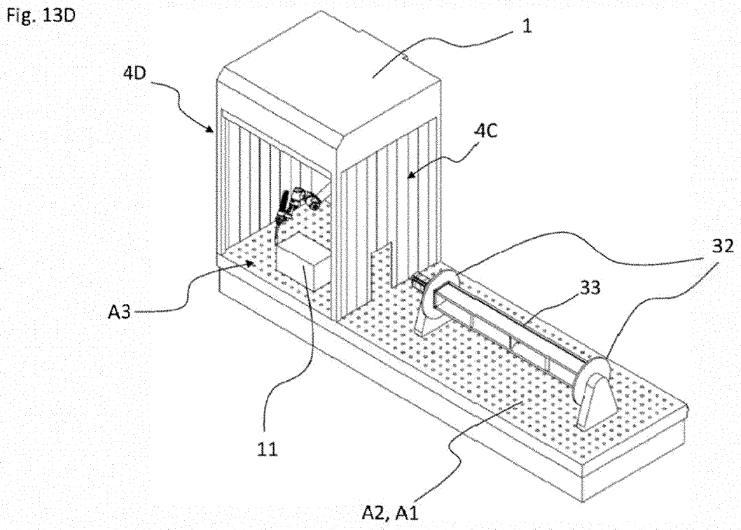

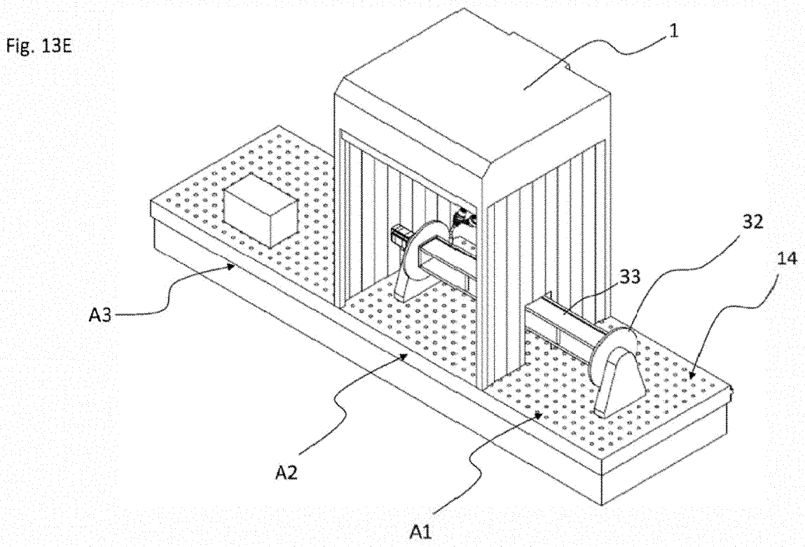

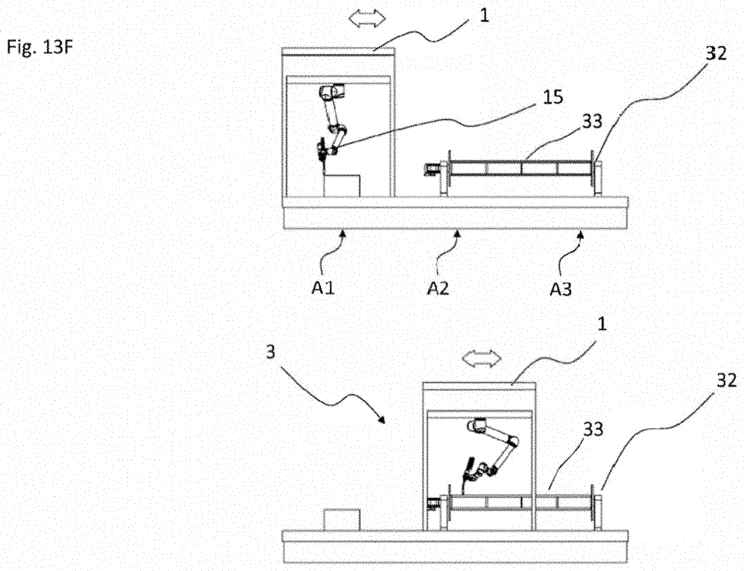

FIGS. 13A-C show a further embodiment of the compact cell Z, in which the design of the protective enclosure 3 as previously mentioned together with the welding robot 15 attached to the cell roof 1, is combined with a welding bench consisting of three working areas A1, A2, A3.

FIG. 13A shows the side view of the compact cell Z with the protective enclosure 3 in the second position, i.e. enclosing the second working area A2. Contrary to the previous embodiments, the working areas A1, A2, A3 in this embodiment are not defined by two or more welding plates, but are arranged one behind the other and overlapping into each other on a single welding bench 8. Here, the first working area A1 again describes, in relation to the front side 4A (see e.g. FIG. 120) of the protective enclosure 3, the front working area A1 of the compact cell Z and the second A2 and third working area A3 respectively describe the middle and rear working area of the invention.

Furthermore, the above mentioned base frame 25 or the guide device 24 is configured in this case in such a way that the protective enclosure 3 can be moved successively from a first position for enclosing the first working area A1 via a second position for enclosing the second working area A2 to at least a third position for enclosing the third working area A3 and back, so that at least every area of the welding bench 8 located under the protective enclosure 3 can be enclosed once by the movement of the protective enclosure 3 and just not enclosed areas are exposed. This has the advantage that any number of working areas can be provided and thus not only one or two welders can prepare or process workpieces 11, 13, 17 in parallel to the welding robot, but the compact cell Z can be assembled as desired depending on the requirements of the respective welding job. Preferably, the movement of the protective enclosure 3 may also be defined more precisely by a control unit, so that the positions of the protective enclosure 3 can be redefined at any time before the respective welding operation.

FIG. 13B also describes the protective enclosure 3 of this embodiment in more detail. The respective roller shutters 5A, 5B, 5C may also comprise protective curtains 32A, 32C, so that when the roller shutters 5A, 5B, 5C are lowered, the protection of the welders is ensured, but at the same time observing the interior of the protective enclosure 3 is made possible. Furthermore, these protective curtains (or roller shutter grille structures) 32A, 32B can preferably close automatically when the welding robot 15 located inside the protective enclosure 3 is carrying out a welding operation, so that spark jumps or possible welding fume emissions can be completely prevented.

FIG. 130 also shows a three-dimensional visualisation of the same embodiment, wherein the roller shutters 5A, 5C of the protective enclosure 3 are still closed. In particular, it can be seen here that the compact cell in this embodiment can be served from each side and the associated protective enclosure 3 can be accessed through at least one roller shutter 5A, 5C on three of four sides of the protective enclosure 3. This device thus offers optimised accessibility, especially in the case of parallel welding operations with a welding robot 15.

FIGS. 13D-F describe another embodiment of the compact cell Z with three working areas A1, A2, A3, in which case an additional receptacle with manipulator 32, aligned along the longitudinal axis of the welding bench plate 14 and positioned on the first and second working areas, has been added.

FIG. 13D shows this embodiment in a three-dimensional view with the protective enclosure 3 in the third position, i.e. over the third working area A3. In this case, the manipulator 32 is equipped with a rotational axis provided for clamping a workpiece 33, here aligned along the long side of the welding bench plate 14, which rotatably supports the workpiece 33 and thus makes it accessible to the welding robot 15 from all sides during welding operation. Here, the shapes and degrees of freedom of the manipulator 32 are not limited to those shown in FIGS. 13D-F. Thus, in a further embodiment, the manipulator 32 can preferably also translate the workpiece 33 with respect to its original position or rotate it in more than one axis, thus ensuring optimal processing of the latter by the welding robot 15. In addition, several manipulators 32 can also be implemented, preferably also on several welding bench plates 14.

In addition, the side walls 4C, 4D of the protective enclosure 3 are provided with lightweight welding curtains for optimised movement of the protective enclosure 3 and to protect the manipulator 32 from possible contact damage, so that especially when moving the protective enclosure 3 from a working area A3 without a manipulator 32 (see FIG. 13D) to a working area A1, A2 provided with a manipulator 32, as shown in FIG. 13E, it is not possible to damage the workpiece 33 inserted in the manipulator 32 even when the side walls 4C, 4D are lowered. Preferably, moreover, in a further embodiment of this protective enclosure 3, openings or aperture hatches may be provided on the side walls 4C, 4D, following the shape of the manipulator 32 or of the workpiece 33, whereby the enclosure of the manipulator or of the workpiece 33, 32 or of parts of the latter can be carried out entirely without contact with the protective enclosure 3.

By means of such a structure, especially due to the integrated manipulator 32, it is thus possible to process the workpieces 33 even more precisely by the welding robot 15. Furthermore, due to the modularly adjustable working areas A1, A2, A3, as well as the freely selectable size of the manipulator 32, partial processing steps can also be performed on one and the same workpiece 33.

The illustrations in FIG. 13F, in which the embodiments already shown in FIGS. 13D and 13E are again shown as a front view, allow this to be shown in more detail: Since the workpiece inserted in the manipulator 32, e.g. by moving the protective enclosure 3 into the second position (FIG. 13F, below), can only be partially enclosed by the protective enclosure 3 and thus can also only be partially processed by the welding robot 15 mounted on the roof 1, the welder still has the option of preparing and further modifying the portions of the workpiece 33 that are still free, for example in the first working area A1. This means that parallelised welding operations can also be carried out on larger workpieces and even complex processing steps that require a multi-stage preparation or treatment process on a workpiece can be realised without any problems.

The protective enclosure shown in FIG. 13E comprises four sides with a welding curtain on two sides and a roller shutter device on each of the other two sides. The cell side wall can therefore be formed by a roller shutter or welding curtain in this further embodiment, so that easy accessibility from all sides of the protective enclosure is possible. The protective enclosure in this further embodiment is configured as a movable/displaceable portal on four columns, wherein a roller shutter device and/or a welding curtain may preferably be provided between each of these columns.

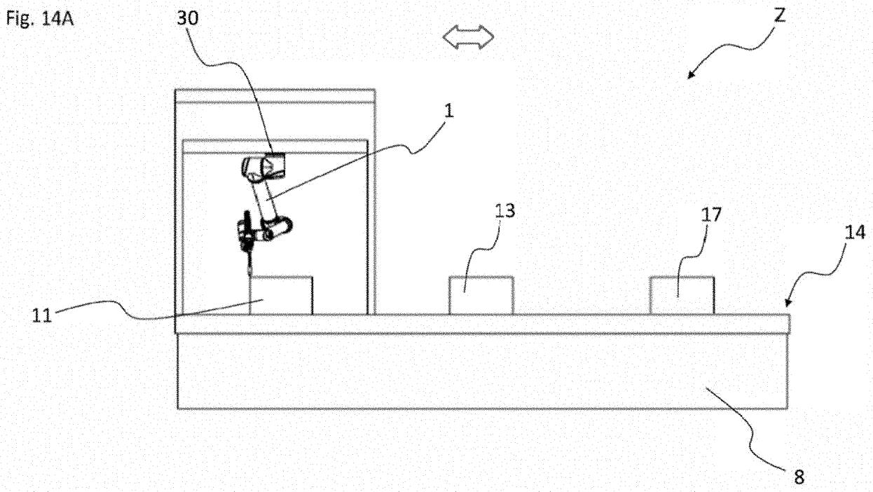

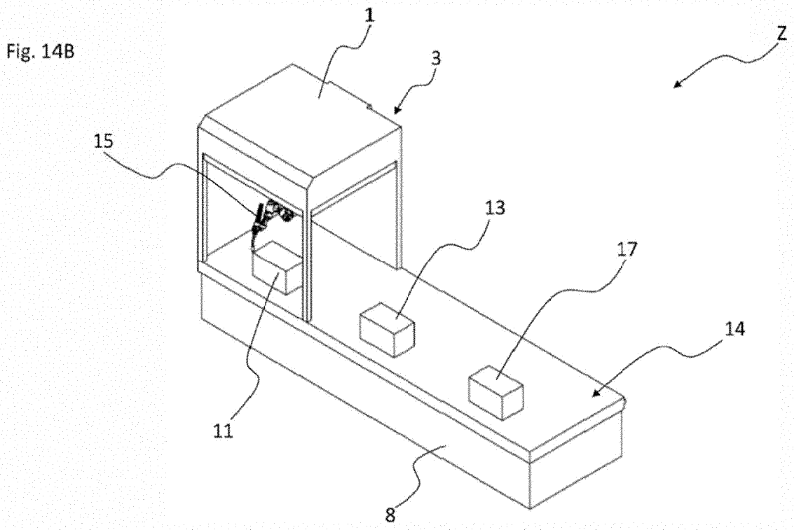

FIGS. 14A and 14B further describe the embodiment of the compact cell Z already shown in FIGS. 13A-C, in which case the three roller shutters 5A, 5C of the protective enclosure were opened and the protective enclosure 3 was moved to the third position or over the third working area A3. Due to the positioning of the welding robot 15 by means of the connecting device 31 on the cell roof 1, the workpiece 11 can be optimally processed again, while the additional movement of the welding robot 15 by the protective enclosure 3 allows the welding robot 15 to be positioned in another working area A1, A2 after completion of the work. Preferably, this process may be automated, e.g. by the above mentioned control unit (not shown), so that an optimised work chain can be made possible. Thus, this embodiment of the compact cell Z realises an optimal accessibility of the individual working areas in combination with the possibility to expand and automate parallel welding operations as desired.

1. A compact cell having a protective enclosure for welding operations and/or cutting operations by means of welding robots, the compact cell comprising:
a cell roof and at least one cell side wall, wherein the cell side wall is connected to the cell roof;
the protective enclosure, comprising at least the cell roof and the at least one cell side wall; and
at least a first and a second working area for welding operations;
wherein the protective enclosure is configured to be at least in both directions movable and in a first position encloses the first working area and exposes the second working area and in a second position encloses the second working area and exposes the first working area.

2. Compact cell according to claim 1, wherein the protective enclosure comprises at least one roller shutter device, and the roller shutter device in an open position allows access to the working area enclosed by the protective enclosure and in a closed position closes off the working area for a welding operation.

3. Compact cell according to claim 1, wherein a welding robot is received on the protective enclosure so it can be moved with it, in particular on the cell roof and/or on the cell side wall, and wherein the welding robot is preferably a collaborative robot.

4. Compact cell according to claim 1,
wherein the protective enclosure includes, adjacent to the cell side wall, at least a cell front side with a front roller shutter device and a cell rear side with a rear roller shutter device, and
wherein the protective enclosure can at least partially be closed by the front and/or rear roller shutter device.

5. Compact cell according to claim 1,
wherein the protective enclosure includes at least one roller shutter device and/or a welding robot which are received in the cell roof and/or on cell side walls, and the protective enclosure, in the closed position of the at least one roller shutter device, allows the working area to be closed off on all sides, and
wherein the roller shutter devices preferably can be opened and closed independently of each other.

6. Compact cell according to claim 1, wherein the compact cell is set up for an alternating welding operation, so that the protective enclosure in the second position encloses the second working area for the welding operation and at the same time exposes the first working area, in particular for access by an operator for setting up or changing workpieces in other working areas, and wherein the protective enclosure can be moved at least from the second position into the first position for a change of working area, for enclosing the first working area, simultaneously exposing at least the second working area.

7. Compact cell according to claim 1, wherein at least a first, a second and at least a further working area are arranged successively along a longitudinal axis, and
the protective enclosure encloses the working area by moving the protective enclosure in a linear direction successively along the longitudinal axis.

8. Compact cell according to claim 1, wherein a working area exposed by the protective enclosure is accessible from at least one side of the working area and from the top of the working area, in particular to enable the working area to be loaded by a crane from above.

9. Compact cell according to claim 1,
wherein the roller shutter device comprises at least one roller shutter capable of completely closing the front or rear of the protective enclosure; and
the roller shutters of the roller shutter device can be interconnectable to further divide the working areas into sub-working areas.

10. Compact cell according to claim 1,
wherein the roller shutter device comprises at least one roller shutter mount and the roller shutter mount is provided on the inside in the cell roof, wherein the roller shutter mount moves a roller shutter preferably from the cell roof to the floor of the working area to close the protective enclosure and from the floor of the working area to the cell roof to open the protective enclosure.

11. Compact cell according to claim 1, wherein the working areas can be divided by at least one further partition wall into additional partial working areas, wherein the at least one further partition wall is preferably a roller shutter.

12. Compact cell according to claim 1, wherein the partial working areas can be enclosed from all sides by the respective roller shutters of the roller shutter device and the partition wall of the protective enclosure and the roller shutters of the partial working areas can be opened and closed independently of one another.

13. Compact cell according to claim 1, wherein each working area comprises at least one modular welding bench, wherein the modular welding bench includes a tabletop with a perforated grid for precise positioning of workpieces, a manipulator and/or the welding robot.

14. Compact cell according to claim 1,
wherein the protective enclosure comprises at least one roller shutter device on each of three sides and particularly preferably on each of four sides, and
the roller shutter devices can completely close the three sides and particularly preferably four sides of the protective enclosure by means of at least one roller shutter in each case, so that the roller shutters and the cell side wall can enclose the working area located under the protective enclosure from all sides.

15. Compact cell according to claim 1, wherein a welding robot is provided in one of the working areas; and the welding robot can be enclosed from all sides by the protective enclosure at least in the first position and/or by the protective enclosure in the second position.

16. Compact cell according to claim 15, wherein the welding robot is movable along at least one axis by a receptacle; and
the receptacle is configured in such a way that it is possible to position the welding robot in all working areas located in the protective enclosure, the receptacle preferably comprising a linear guide and/or an excentric axis, and
the receptacle is provided on the tabletop or on the cell roof or the cell side wall.

17. Compact cell according to claim 1, wherein the protective enclosure comprises at least one linear guide rail for movement and the guide rail is provided on the underside of the cell roof and rests on at least one guide device.

18. Compact cell according to claim 15, wherein the guide device is fixedly connected to a static base frame and the protective enclosure is preferably pneumatically displaceable, and
wherein the base frame is fixedly connected to the modular welding bench.

19. Compact cell according to claim 1, wherein the cell roof comprises at least one extraction opening and/or a movable extraction device which can be moved along by the movement of the protective enclosure.

20. Method for configurating a protective enclosure for welding operations and/or cutting operations by means of welding robots,
wherein the compact cell comprises a cell roof and at least one cell side wall and the cell roof and the cell side wall are connected to each other and form a protective enclosure,
wherein the compact cell comprises at least a first and a second working area for welding operations; and
the protective enclosure is configured to be at least in both directions movable, the method comprising the step:
Moving the protective enclosure from a first position to a second position to enclose one working area and simultaneously expose another working area.
